(19) United States
(12) Patent Application Publication
(10) Pub. No.: US 2007/0013283 A1
(43) Pub. Date: Jan. 18, 2007

(54) Front filter of plasma display panel and fabricating method thereof

(76) Inventors: Ji Hoon Sohn, Anyang-si (KR); Hong Rae Cha, Seoul (KR); Myung Su Jang, Gumi-si (KR); Woon Seo Shin, Gunpo-si (KR)

Correspondence Address: FLESHNER & KIM, LLP, P.O. BOX 221200, CHANTILLY, VA, 20153, US

(21) Appl. No.: 11/478,852

(22) Filed: Jul. 3, 2006

(30) Foreign Application Priority Data
Jul. 4, 2005 (KR) 10-2005-0059697

(51) Int. Cl. H01J 61/40

(52) U.S. Cl. 313/111

(57) ABSTRACT

A front filter of a plasma display panel and fabricating method thereof are disclosed, by which a roll type film filter is fabricated to be attached to the plasma display panel. The present invention includes the steps of preparing a roll type film filter layer including an electromagnetic wave shielding layer cutting off an electromagnetic wave discharged within a panel and laminating the roll type film filter layer on a front panel of the plasma display panel.

This application claims the benefit of the Korean Patent Application No. P2005-0059697, filed on Jul. 04, 2005, which is hereby incorporated by reference as if fully set forth herein.

### BACKGROUND OF THE INVENTION

1. Field of the Invention

The present invention relates to a plasma display panel, and more particularly, to a front filter of a plasma display panel and fabricating method thereof.

2. Discussion of the Related Art

Generally, barrier ribs provided between front and rear substrates partition a plurality of discharge cells in a plasma display panel. And, each of the discharge cells is charged with a primary discharge gas such as Ne, He, a mixed gas of Ne and He and the like and an inert gas containing a small quantity of Xe.

Once an electric discharge is generated by an RF voltage, vacuum ultraviolet rays are generated from the inert gas to excite a fluorescent material. So, the excited fluorescent material emits light to implement an image.

As a next generation display, the above-configured plasma display panel, which enables a thin and light configuration, is in the spotlight.

FIG. 1 is a perspective diagram of a plasma display panel according to a related art.

Referring to FIG. 1, in a front substrate 100 of a plasma display panel, a plurality of sustain electrode pairs are arranged on a front glass 101 that is a display surface on which an image is displayed. In this case, each of a plurality of the sustain electrode pairs consists of a scan electrode 102 and a sustain electrode 103.

In a rear substrate 110, a plurality of address electrodes 113 are arranged on a rear glass 111 to cross with a plurality of the sustain electrode pairs, respectively.

And, the rear and front substrates 110 and 100 are bonded together to be evenly spaced apart in parallel with each other.

On the rear substrate 110, a plurality of stripe or well type barrier ribs 112 are arranged parallel with each other to form a plurality of discharge spaces, i.e., a plurality of discharge cells.

A plurality of the address electrodes 113 are arranged parallel with a plurality of the barrier ribs 112 to generate vacuum ultraviolet rays by performing an address discharge.

An R/G/B fluorescent material 114 is coated on the rear substrate 100 to generate visible rays for an image display in the address discharge.

And, a lower dielectric layer 115 is formed between the address electrode 113 and the fluorescent material 114 to protect the address electrode 113.

Meanwhile, the above-configured related art plasma display panel is fabricated by a glass fabricating process, a front substrate fabricating process, a rear substrate fabricating process and an assembly process.

First of all, the front substrate fabricating process consists of a step of forming a scan electrode and a sustain electrode on a front glass, a step of forming an upper dielectric layer to inhibit a discharge current of the scan and sustain electrodes and to insulate the electrode pair, and a step of forming a protective layer on the upper dielectric layer by depositing MgO to facilitate a discharge condition.

The rear substrate fabricating process consists of a step of forming an address electrode on a rear glass, a step of forming a lower dielectric layer to protect the address electrode, a step of forming a barrier rib on the lower dielectric layer to partition a discharge cell, and a step of forming a fluorescent layer discharging visible rays between the barrier ribs to display an image.

In general, a front filter is provided to a front side of a plasma display panel to cut off an externally discharged electromagnetic wave and to enhance optical characteristics. And, a glass type front filter including a plurality of layers on a glass to perform the above-explained functions is used in the related art.

The glass type front filter is advantageous in being prevented from being damaged by an external shock but has problems of considerable thickness and weight as well as a high product cost.

To solve these problems, a film type front filter has been proposed. The film type front filter consists of a base film, an electromagnetic wave shielding layer on the base film and an anti-reflection layer on the electromagnetic wave shielding layer. Each of these layers is bonded using an adhesive agent or the like.

However, the related art film type front filter has the following problems.

First of all, since the front filter of the plasma display panel, as shown in FIG. 2, needs to be grounded by processing a portion of the electromagnetic wave shielding layer into a bus bar, the bus bar portion should be opened. In the related art, sheets is prepared by cutting an electromagnetic wave shielding layer, a near infrared shielding layer, a color adjusting layer, an anti-reflection layer and the like to correspond to a design in advance and by laminating each of the layers. And, the sheets are attached to the plasma display panel one by one.

Since the respective unit layers are cut and attached one by one, a working efficiency is reduced and limitation is put on process automation. Hence, a yield rate is reduced and a product cost is raised.

### SUMMARY OF THE INVENTION

Accordingly, the present invention is directed to a front filter of a plasma display panel and fabricating method thereof that substantially obviate one or more problems due to limitations and disadvantages of the related art.

An object of the present invention is to provide a front filter of a plasma display panel and fabricating method thereof, by which a roll type film filter is fabricated to be attached to the plasma display panel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of fabricating a front filter in a plasma display panel according to the present invention includes the steps of preparing a roll type film filter layer including an electromagnetic wave shielding layer cutting off an electromagnetic wave discharged within a panel and laminating the roll type film filter layer on a front panel of the plasma display panel.

In another aspect of the present invention, a front filter of a plasma display panel, which is provided to a front side of the plasma display panel, includes a film filter layer including an electromagnetic wave shielding layer cutting off an electromagnetic wave discharged within a panel, wherein the film filter layer is prepared into a roll type and wherein the roll type film filter layer is laminated on a front panel of the plasma display panel.

In another aspect of the present invention, a method of fabricating a plasma display panel includes the steps of preparing a film filter layer including an electromagnetic wave shielding layer into a roll type, preparing a film layer including an anti-reflection layer into the roll type, laminating the film filter layer on a front panel of the plasma display panel, and forming a front filter by laminating the film layer including the anti-reflection layer on the film filter layer.

In another aspect of the present invention, a plasma display panel includes a front panel and a front filter on the front panel, the front filter including an electromagnetic wave shielding layer and an anti-reflection layer, wherein the front panel is formed by preparing a film filter layer including the electromagnetic wave shielding layer into a roll type, preparing a film including the anti-reflection layer into the roll type and laminating the film filter layer and the film including the anti-reflection layer on the front panel of the plasma display panel in turn.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective diagram of a plasma display panel according to a related art;

FIG. 2 is a cross-sectional diagram of a film type front filter of a plasma display panel according to a related art;

FIG. 3 is a cross-sectional diagram of a front filter of a plasma display panel according to a first embodiment of the present invention;

FIG. 4 is a layout of a front filter of a plasma display panel according to a first embodiment of the present invention;

FIG. 5 is a diagram for explaining a method of attaching a front filter to a surface of a panel according to a first embodiment of the present invention;

FIG. 6 is a cross-sectional diagram of a front filter of a plasma display panel according to a second embodiment of the present invention;

FIG. 7 is a layout of a front filter of a plasma display panel according to a second embodiment of the present invention; and

FIG. 8 is a diagram for explaining a method of fabricating a plasma display panel according to a third embodiment of the present invention.

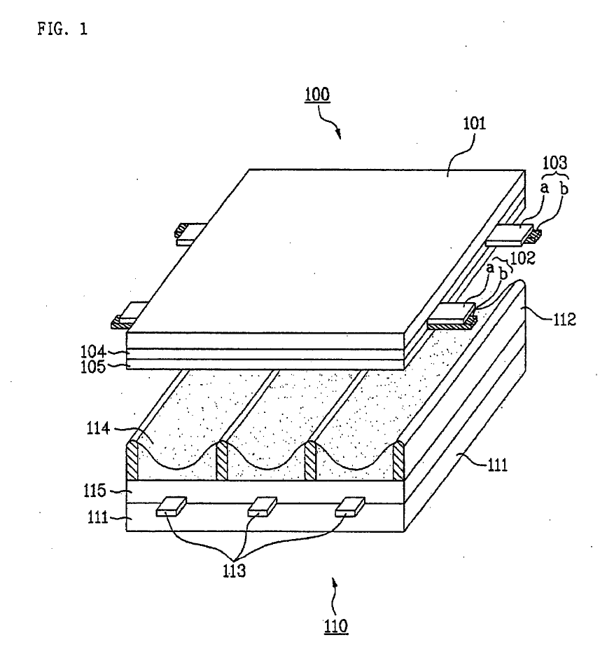

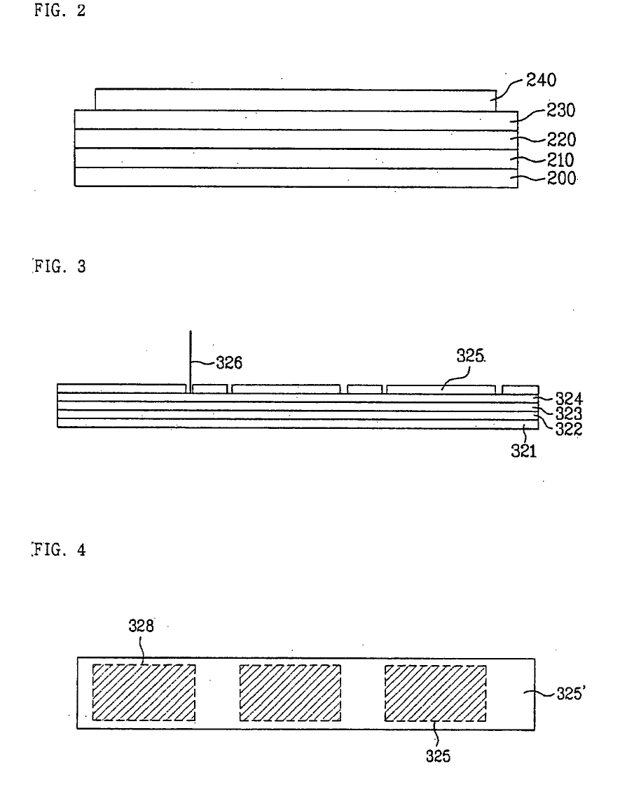

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 3 is a cross-sectional diagram of a front filter of a plasma display panel according to a first embodiment of the present invention, and FIG. 4 is a layout of a front filter of a plasma display panel according to a first embodiment of the present invention.

A plasma display panel according to a first embodiment of the present invention is explained with reference to FIG. 3 as follows.

Referring to FIG. 3, a color correcting layer 322, a near infrared shielding layer 323, an electromagnetic shielding layer 324 and an anti-reflection layer 325 are sequentially stacked on a base film 321.

Preferably, the base film 321 is formed of PET or the like. And, the base film 321 plays a role in protecting and supporting each of the unit layers.

The color correcting layer 322 is able to enhance optical characteristics of a display panel in a manner of lowering luminance of red and green of visible rays discharged from the panel and raising luminance of blue.

The near infrared shielding layer 323 enables a device transferring a signal using infrared such a remote controller and the like to operate normally in a manner of shielding near infrared rays exceeding a reference level not to be discharged from the panel.

The electromagnetic wave shielding layer 324 plays a role in shielding EMI (electromagnetic interference) not to be discharged from the panel.

The anti-reflection layer 325 plays a role in enhancing a contrast of the display panel in a manner of preventing an external incident light from being externally discharged from the panel.

Alternatively, the near infrared shielding layer 322 and the color correcting layer 323 can be included in components of an adhesive layer used in bonding the respective layers.

As mentioned in the foregoing description, the front filter needs to be grounded by processing a portion of the electromagnetic shielding layer 324 with a bus bar. In order to open the bus bar portion, half-cutting is performed on a portion of the anti-reflection layer 325. So, the portion of the anti-reflection layer 325 is half-cut using a blade 326.

FIG. 4 is a layout of a front filter of a plasma display panel according to a first embodiment of the present invention.

Referring to FIG. 4, a trace 328 of the half-cutting performed on the anti-reflection layer 325 remains.

The half-cutting means a process for cutting a portion of a part 328′ to be cut. The half-cutting facilitates a bus bar portion to be opened by removing a rest portion of a front filter formed on a panel, which will be explained later.

Preferably, a protective film formed of PET or the like is formed on the anti-reflection layer 325 to perform a function of protecting each of the unit layers.

Preferably, the base film 321 and the protective film are removed in the course of the process for forming the front filter on the panel.

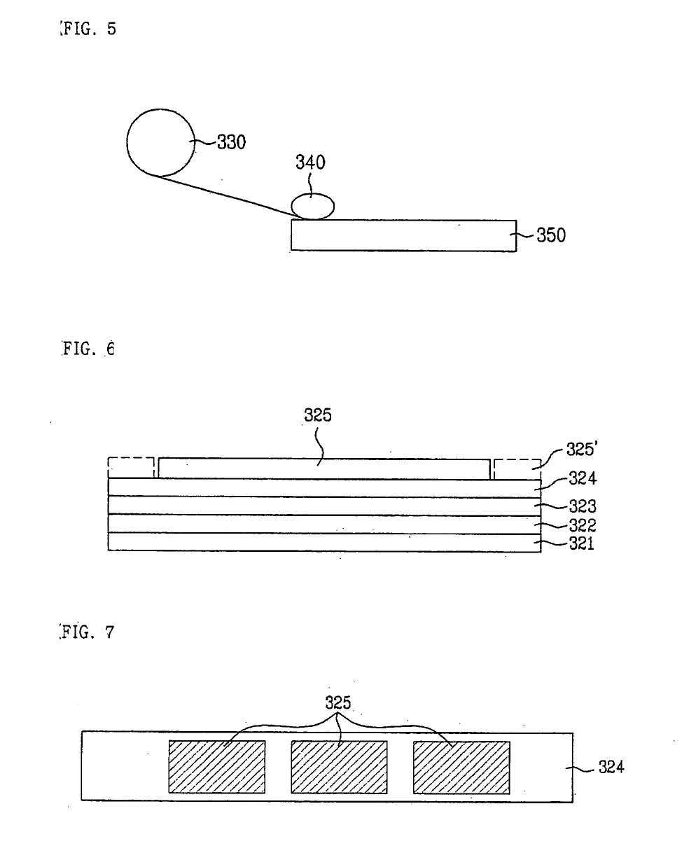

A method of attaching a front filter to a surface of a panel according to a first embodiment of the present invention is explained with reference to FIG. 5 as follows.

FIG. 5 is a diagram for explaining a method of attaching a front filter to a surface of a panel according to a first embodiment of the present invention.

Referring to FIG. 5, a front filter 330 is wound on a roller. The front filter 330 is attached to a surface of a panel 350 by a lamination roller 340.

In particular, the front filer 330 having been wound on the roller is attached to the panel by laminating.

Subsequently, the aforesaid half-cut portion is removed to complete a process of forming the front filter.

As the half-cut portion is completely removed, a bus bar portion is fully opened to enable an electromagnetic wave shielding layer to be grounded.

In this case, the half-cutting process can be executed after the front filter has been wound on the roller. Alternatively, after the half-cutting process has been performed, the front filter can be wound on the roller.

Hence, in the above-explained front filter and the method of fabricating a plasma display panel using the front filter, the anti-reflection layer configuring the front filter is half-cut in advance. The front filter is then attached to the display panel to facilitate the step of removing the bust bar portion.

FIG. 6 is a cross-sectional diagram of a front filter of a plasma display panel according to a second embodiment of the present invention, and FIG. 7 is a layout of a front filter of a plasma display panel according to a second embodiment of the present invention.

A front filter of a plasma display panel according to a second embodiment of the present invention is explained with reference to FIG. 6 and FIG. 7 as follows.

Referring to FIG. 6, a second embodiment of the present invention is basically identical to the aforesaid first embodiment of the present invention.

Preferably, a color correcting layer 322, a near infrared shielding layer 323, an electromagnetic wave shielding layer 324 and an anti-reflection layer 325 are sequentially stacked on a base film 321.

Yet, unlike the first embodiment of the present invention, the second embodiment of the present invention is characterized in that the anti-reflection layer 325 is fully cut. In particular, it is preferable that the anti-reflection layer 325 is formed smaller than the electromagnetic wave shielding layer 324 in size to enable the electromagnetic wave shielding layer 324 to be grounded.

FIG. 7 is a layout of the above-configured front filter according to the second embodiment of the present invention.

Referring to FIG. 7, as the anti-reflection layer 325 has a relatively smaller size, a portion of the electromagnetic wave shielding layer 324 is exposed.

A method of forming the above-configured front filter on a display panel according to the second embodiment of the present invention is explained as follows.

First of all, the above-explained front filter according to the second embodiment of the present invention is formed on a surface of the roller.

Subsequently, a surface of a panel is laminated by the roller to form the front filter on the surface of the panel. Namely, the laminating method of the front filter according to the second embodiment of the present invention is basically identical to that according to the first embodiment of the present invention. Yet, since the anti-reflection layer is cut in advance, the cutting step of the method of the first embodiment of the present invention is unnecessary for the method of the second embodiment of the present invention.

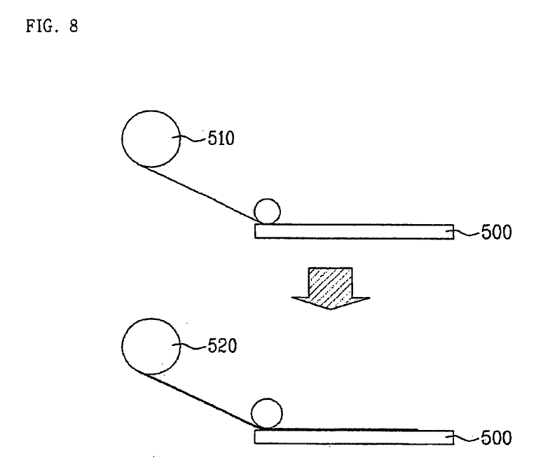

A method of fabricating a plasma display panel according to a third embodiment of the present invention is explained with reference to FIG. 8 as follows.

FIG. 8 is a diagram for explaining a method of fabricating a plasma display panel according to a third embodiment of the present invention.

Referring to FIG. 8, a method of fabricating a plasma display panel according to a third embodiment of the present invention is basically similar to the related art method but differs from the related art method in a method of forming a front filter. In the first or second embodiment of the present invention, the front filter is attached to the panel using one roller. Yet, the third embodiment of the present invention uses a plurality of rollers.

First of all, an electromagnetic wave shielding layer is formed on a surface of a first roller 420. The electromagnetic wave shielding layer is formed on a base film. Preferably, a near infrared shielding layer and a color correcting layer are further formed.

Subsequently, the first roller 420 is laminated on a surface of a panel 400. A laminating method is identical to that of the second embodiment of the present invention. After completion of the laminating process, an electromagnetic wave shielding layer or the like is formed on the panel 400.

An anti-reflection layer is formed on a surface of a second roller 420. Preferably, the anti-reflection layer is formed after a portion to be processed for a bus bar has been removed.

The anti-reflection layer is formed on the electromagnetic shielding layer or the like formed on the panel 400 by laminating the second roller 420. In this case, since a peripheral portion of the anti-reflection layer is already cut, a bus bar portion on the electromagnetic wave shielding layer is opened to enable a ground.

Hence, a separate cutting process is unnecessary after completion of the front filter forming process.

In the method according to the third embodiment of the present invention, two rollers are used. Alternatively, the present method is able to use three or more rollers.

Preferably, the anti-reflection layer is formed on a surface of a separate roller to laminate. More preferably, a portion to be processed for a bus bar is previously cut to be formed on a roller surface.

In the method of fabricating the plasma display panel according to the present invention, processes for forming other elements is identical to those of the related art except the process for forming the front filter.

And, it is apparent that the front filter and the method of fabricating the plasma display panel using the same according to the present invention are applicable to other display panels including a liquid crystal display panel and the like.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of fabricating a front filter in a plasma display panel, comprising the steps of:
preparing a roll type film filter layer including an electromagnetic wave shielding layer cutting off an electromagnetic wave discharged within a panel; and
laminating the roll type film filter layer on a front panel of the plasma display panel.

2. The method of claim 1, wherein the film filter layer further includes a near infrared shielding.

3. The method of claim 1, wherein the film filter layer further includes a color correcting layer.

4. The method of claim 1, wherein an anti-reflection layer is formed on a surface of the film filter layer.

5. The method of claim 1, wherein a portion of the anti-reflection layer is half-cut to represent a boundary of a bus bar for a ground connection.

6. The method of claim 5, wherein the film filter layer is prepared into a roll type by half-cutting the electromagnetic wave shielding layer.

7. The method of claim 5, wherein the electromagnetic wave shielding layer is half-cut after the film filter layer has been prepared into the roll type.

8. The method of claim 5, further comprising the step of forming a bus bar by removing a portion of the half-cut anti-reflection layer.

9. The method of claim 4, wherein the anti-reflection layer is formed in a manner that a portion of the anti-reflection layer to be removed for a ground connection is removed in advance.

10. A front filter of a plasma display panel, the front filter provided to a front side of the plasma display panel, the front filter comprising a film filter layer including an electromagnetic wave shielding layer cutting off an electromagnetic wave discharged within a panel, the film filter layer prepared into a roll type, the roll type film filter layer laminated on a front panel of the plasma display panel.

11. The front filter of the plasma display panel of claim 10, wherein the film filter layer further includes a near infrared shielding.

12. The front filter of the plasma display panel of claim 10, wherein the film filter layer further includes a color correcting layer.

13. The front filter of the plasma display panel of claim 10, wherein an anti-reflection layer is formed on a surface of the film filter layer.

14. The front filter of the plasma display panel of claim 13, wherein the film filter layer is prepared into the roll type by half-cutting a portion of the anti-reflection layer to represent a boundary of a bus bar for a ground connection.

15. The front filter of the plasma display panel of claim 13, wherein the anti-reflection layer is half-cut to represent a boundary of a bus bar for a ground connection after the film filter layer has been prepared into the roll type.

16. The front filter of the plasma display panel of claim 14 or claim 15, the half-cut portion of the anti-reflection layer is removed after the film filter layer has been laminated on the front panel.

17. The front filter of the plasma display panel of claim 13, wherein the anti-reflection layer is formed on the surface of the film filter layer in a manner that a portion of the anti-reflection layer to be removed for a ground connection is removed in advance.

18. A method of fabricating a plasma display panel, comprising the steps of:
preparing a film filter layer including an electromagnetic wave shielding layer into a roll type;
preparing a film layer including an anti-reflection layer into the roll type;
laminating the film filter layer on a front panel of the plasma display panel; and
forming a front filter by laminating the film layer including the anti-reflection layer on the film filter layer.

19. The method of claim 18, wherein the anti-reflection layer is formed smaller than the film filter layer.

20. The method of claim 18, further comprising the step of forming a bus bar for a ground connection by removing a portion of the laminated anti-reflection layer.

21. A plasma display panel comprising:
a front panel; and
a front filter on the front panel, the front filter including an electromagnetic wave shielding layer and an anti-reflection layer,
wherein the front panel is formed by preparing a film filter layer including the electromagnetic wave shielding layer into a roll type, preparing a film including the anti-reflection layer into the roll type and laminating the film filter layer and the film including the anti-reflection layer on the front panel of the plasma display panel in turn.

22. The plasma display panel of claim 21, wherein the anti-reflection layer is formed smaller than the film filter layer.

23. The plasma display panel of claim 21, wherein a bus bar for a ground connection is formed by laminating the film including the anti-reflection layer on the front panel by removing a portion of the laminated anti-reflection layer.
